(19) United States
(12) Patent Application Publication
(10) Pub. No.: US 2008/0300946 A1
(43) Pub. Date: Dec. 4, 2008

(54) METHODS, SYSTEMS, AND COMPUTER PROGRAM PRODUCTS FOR IMPLEMENTING AN END-TO-END PROJECT MANAGEMENT SYSTEM

(75) Inventors: Mark G. Clark, Rochester, MN (US); Michael E. Cropp, Lagrangeville, NY (US); Bohdan Demczar, Hyde Park, NY (US); Richard J. Fishbune, Rochester, MN (US); Justin Gilbert, Mabel, MN (US); Mahesh J. Jesrani, Hopewell Junction, NY (US); Ruediger Johner, Frankfurt (DE); Robert C. Kulle, Port St. Lucie, FL (US); Alan D. Lemberger, Pleasant Valley, NY (US); John S. Maresca, Hopewell Junction, NY (US); Suheil M. Nassar, Cary, NC (US); Timothy R. Tennant, Durham, NC (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/756,113

(22) Filed: May 31, 2007

(51) Int. Cl. G06Q 90/00

(52) U.S. Cl. 705/8

(57) ABSTRACT

Methods, systems and computer program products for implementing an end-to-end integrated product development management system are provided. A method includes providing a user system with a link to a data source and an analysis tool via a user interface in response to a project opportunity selection for a proposed product. The method also includes receiving results of an analysis performed by the user system in response to implementing the analysis tool, and creating a project record for the project opportunity selection in response to determining an approval of the project opportunity selection. The method further includes creating a project plan by mapping data fields in the project record to corresponding data entries relating to a project phase, project task, project task tool, project task timetable, project task measurement, data source, and project team selected by the user system via the user interface.

### BACKGROUND OF THE INVENTION

The present disclosure relates generally to integrated product development management and, in particular, to methods, systems, and computer program products for implementing an end-to-end integrated product development management system.

With an overriding goal of improving quality and being more proactive in product designs, businesses are relying upon various measurement-based strategies that focus on process improvement and variation reduction, e.g., Six Sigma, Design for Six Sigma, Lean Sigma, as well as company-branded methodologies. Some practices are directed to providing incremental improvements in a process or product, whereas others focus on new product/design development. As these individual practices or methodologies are not easily or readily congregated, businesses have not been able to reap the full extent of the benefits associated with each methodology. For example, some companies have demonstrated how to select and when to use the various methodologies for individual company application, yet this practice is not repeatable for other companies. Other companies are using only one approach with questions on how to leverage the other approaches.

Furthermore, when seeking an end-to-end solution, current practices exclude natural extensions of the entire value chain (e.g., tools, suppliers, industry partners, etc.). When considering a business' integrated product development process, e.g., there is a partial exclusion of design for quality analytical techniques and tools. Although some techniques and tools exist in today's environment, there is still a need to bring these tools together in a fashion that supports the entire product/process from concept selection through life-cycle management.

What is needed, therefore, is a unified methodology that integrates various measurement-based strategies with related analytical tools and data sources for facilitating new product development, as well as process improvement and variation reduction, from product conception through lifecycle management.

### BRIEF SUMMARY OF THE INVENTION

Exemplary embodiments of the invention include methods for implementing an end-to-end integrated product development management system. A method includes providing a user system with a link to a data source and an analysis tool via a user interface in response to a project opportunity selection for a proposed product. The method also includes receiving results of an analysis performed by the user system in response to implementing the analysis tool, and creating a project record for the project opportunity selection in response to determining an approval of the project opportunity selection. The method further includes creating a project plan by mapping data fields in the project record to corresponding data entries relating to a project phase, project task, project task tool, project task timetable, project task measurement, data source, and project team selected by the user system via the user interface.

Additional embodiments include systems for implementing an end-to-end integrated product development management system. A system includes a host system executing an integrated product development management application. The integrated product development management application implements a method. The method includes providing a user system with a link to a data source and an analysis tool via a user interface of the integrated product development management application in response to a project opportunity selection for a proposed product. The method also includes receiving results of an analysis performed by the user system in response to implementing the analysis tool, and creating a project record for the project opportunity selection in response to determining an approval of the project opportunity selection. The method further includes creating a project plan by mapping data fields in the project record to corresponding data entries relating to a project phase, project task, project task tool, project task timetable, project task measurement, data source, and project team selected by the user system via the user interface.

Further embodiments include computer program products for implementing an end-to-end integrated product development management system. A computer program product includes instructions for causing a computer to implement a method. The method includes providing a user system with a link to a data source and an analysis tool via a user interface in response to a project opportunity selection for a proposed product. The method also includes receiving results of an analysis performed by the user system in response to implementing the analysis tool, and creating a project record for the project opportunity selection in response to determining an approval of the project opportunity selection. The method further includes creating a project plan by mapping data fields in the project record to corresponding data entries relating to a project phase, project task, project task tool, project task timetable, project task measurement, data source, and project team selected by the user system via the user interface.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a system upon which integrated product development management functions may be implemented in accordance with exemplary embodiments;

FIG. 2 is a flow diagram describing a process for implementing integrated product development management functions in accordance with exemplary embodiments;

FIG. 3 is a computer screen window illustrating a user interface for initiating a project opportunity request in accordance with an exemplary embodiment;

FIG. 4 is a computer screen window illustrating a user interface for creating a project plan in accordance with an exemplary embodiment;

FIG. 5 is a project record illustrating data fields used by the integrated product development management functions in accordance with an exemplary embodiment;

FIG. 6 is a computer screen window illustrating a project charter template used by the integrated product development management functions in accordance with an exemplary embodiment;

FIG. 7 is a computer screen window illustrating a FMEA design template used by the integrated product development management functions in accordance with an exemplary embodiment; and

FIG. 8 is a computer screen window illustrating a FMEA process template used by the integrated product development management functions in accordance with an exemplary embodiment.

The detailed description explains the exemplary embodiments of the invention, together with advantages and features, by way of example with reference to the drawings.

### DETAILED DESCRIPTION OF THE INVENTION

In accordance with exemplary embodiments, an end-to-end integrated product development management system and method are provided. The integrated product development management system includes a development methodology that uses proactive and predictive analytical techniques to improve the robustness of product performance to ensure that the end-to-end design to launch activities produce products that lead to the success of a company. In addition, the integrated product development management functions incorporate the use of analytical techniques and statistical tools to solve production related problems and drive continuous product and process improvements.

The exemplary integrated product development management processes manage the business rules and include a web application providing a system-generated methodology for facilitating project planning from conception through end of life. Additionally, the integrated product development management application 100 integrates a variety of tools and data sources with selected business rules for providing integrated product development management functions. The project plans are generated from execution of the business process and the project plans are stored and updated in a tracking database which may be used as a search and reference tool for future project planning activities.

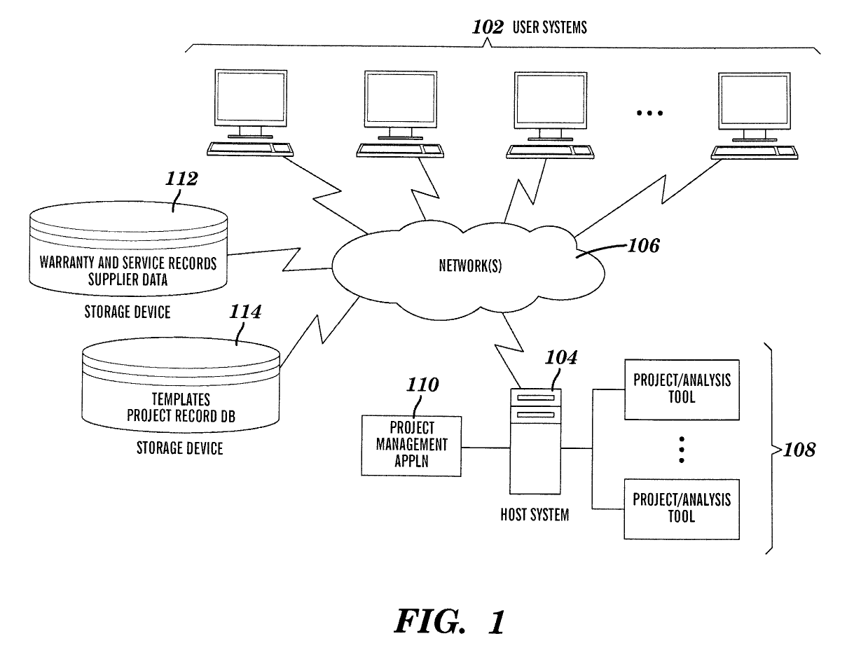

The processes described in FIGS. 1-8 are directed to a computer electronics manufacturing enterprise; however, it will be understood that the exemplary embodiments are not so limited, but rather any type of industry that manufactures products, e.g., automotive industry, may utilize the project planning processes described herein.

Referring now to FIG. 1, a system upon which the integrated product development management processes may be implemented in accordance with exemplary embodiments will now be described. The system of FIG. 1 includes a host system 104 executing computer instructions for performing integrated product development management functions. As shown in FIG. 1, the host system 104 executes an integrated product development management application 110 (also referred to herein as “project management application”) as will be described further herein. The system of FIG. 1 also includes user systems 102 through which end users at one or more geographic locations may contact the host system 104. The user systems 102 are coupled to the host system 104 via one or more network(s) 106. Each user system 102 may be implemented using a general-purpose computer executing a computer program for carrying out the processes described herein. The user systems 102 may be personal computers (e.g., a lap top, a personal digital assistant) or host attached terminals. If the user systems 102 are personal computers, the processing described herein may be shared by a user system 102 and the host system 104 (e.g., by providing an applet to the user system 102).

In an exemplary embodiment, the system of FIG. 1 represents an electronics manufacturing enterprise whereby the host system 104 executes the integrated product development management application 110 on behalf of various enterprise entities (i.e., user systems 102). User systems 102 may be operated by one or more executive-level individuals, finance specialists, procurement specialists, production team members, marketing specialists, and technology team members, to name a few. Via a user interface of the integrated product development management application 110, a core group of project team members that span the various aforementioned entities are selected for implementing the integrated product development management processes as described further herein.

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet and Internet) so that not all user systems 102 are coupled to the host system 104 through the same network. One or more of the user systems 102 and the host system 104 may be connected to the network 106 in a wireless fashion. In one embodiment, the network is an intranet and one or more user systems 102 execute a web browser to contact the host system 104 through the network 106. In another exemplary embodiment, the user system 102 is connected directly (i.e., not through the network 106) to the host system 104.

The host system 104 may be directly connected to, contain, or otherwise engage in communications with one or more storage devices. As shown in FIG. 1, the host system is in communication with two storage devices 112 and 114 over network(s) 106. Each of the storage devices 112 and 114 may be implemented using a variety of devices for storing electronic information. The storage devices 112 and 114 may be logically addressable as a consolidated data source across a distributed environment that includes a network 106. Information stored in the storage devices 112 and 114 may be retrieved and manipulated via the host system 104. In an exemplary embodiment, the storage device 112 houses product warranty records, service records, and supplier information. The storage device 114 houses templates provided by the integrated product development management application 110 and project records created via the integrated product development management application 110. The storage device 114 also serves as a tracking database for the integrated product development management functions. These stored elements will be described further herein. In an exemplary embodiment, the host system 104 operates as a database server and coordinates access to application data including data stored on storage devices 112 and 114. While only two storage devices 112 and 114 are shown in FIG. 1, it will be understood that any number of storage devices may be utilized for realizing the exemplary embodiments of the invention.

The host system 104 depicted in FIG. 1 may be implemented using one or more servers operating in response to a computer program stored in a storage medium accessible by the server. The host system 104 may operate as a network server (e.g., a web server) to communicate with the user systems 102. The host system 104 handles sending and receiving information to and from the user systems 102 and can perform associated tasks. The host system 104 may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs to provide integrated product development management functions (e.g., the integrated product development management application 110). In addition, the host system 104 executes a variety of business and analytical tools, as well as related methodologies in support of the integrated product development management functions, such as, e.g., quality function deployment (QFD), Kano analysis, Triptych®, Affinity® project development, Ishikawa diagrams, Theory of Inventive Problem Solving (TRIZ), Design modeling, Design of Experiments (DOEs), Pugh method, Topsis, Supplier selection, failure mode and effect analyses (FMEAs), statistical software such as Minitab® Statistical Software, Analysis of Variance (ANOVA), Regression analyses, Gauge Repeatability and Reproducibility (Gage R&R), design test and validation, and other similar types of tools. These tools and methodologies are collected referred to herein as project/analysis tools 108. The integrated product development management application 110 and user interface enable customized integration of the project/analysis tools 108, as well as seamless integration of various data repositories (e.g., storage devices 112 and 114). Processing of the integrated product development management application 110 may be shared by the user system 102 and the host system 104 by providing an application (e.g., java applet) to the user system 102. Alternatively, the user system 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

As described above, the integrated product development management application 110 includes a user interface for enabling end users of user systems 102 (e.g., core project team members) to enter data that is processed by the application 110. The user interface includes various screens relating to project opportunity requests and project plans as described further herein.

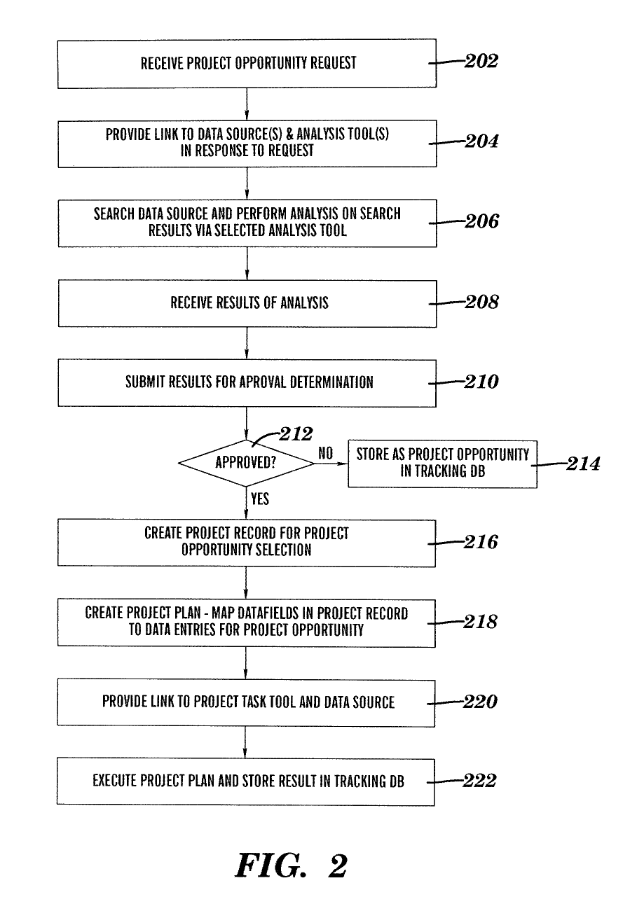

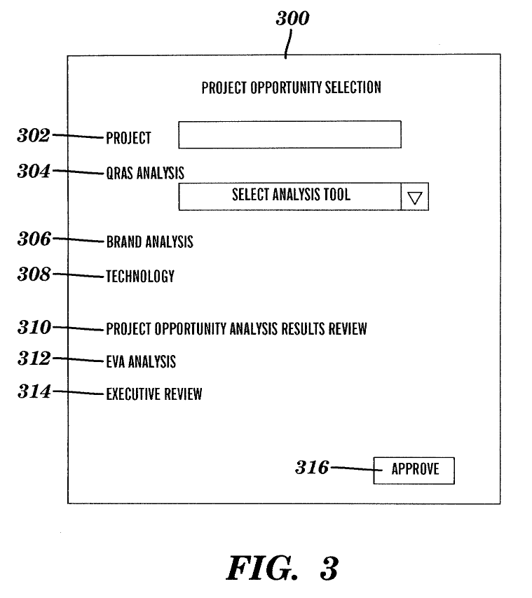

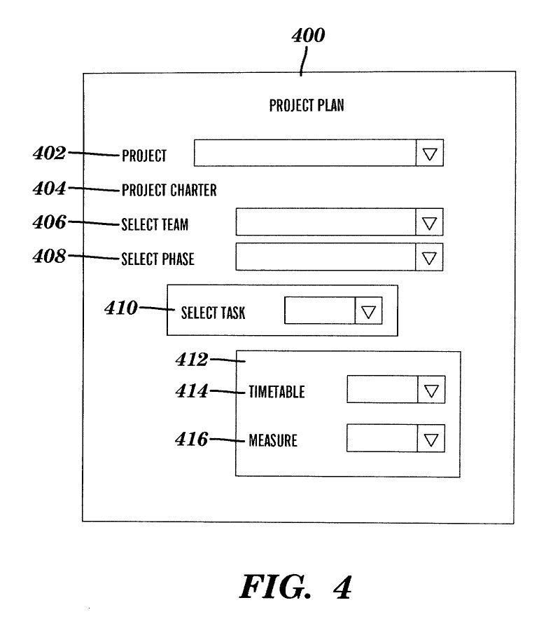

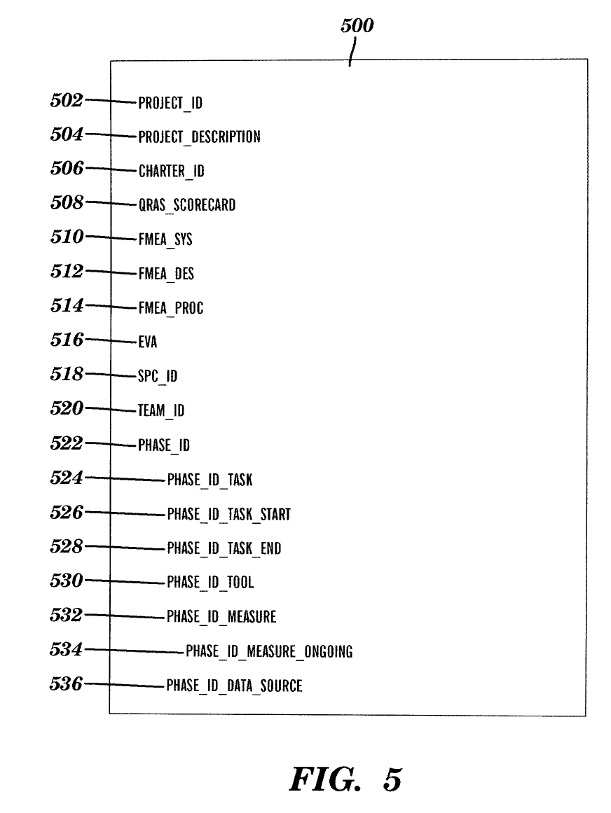

Turning now to FIG. 2, an exemplary process for implementing the integrated product development management processes will now be described. The integrated product development management application 110 includes a user interface having various screens for prompting and receiving information from a plurality of entities (e.g., core team members of user systems 102). Exemplary user interface screens for entering the information are shown and described in FIGS. 3 and 4. The data entered via the user interface screens 300 and 400 of FIGS. 3 and 4 is captured in a project record. FIG. 5 illustrates an exemplary project record including data fields for use by the integrated product development management application 110. The data fields are mapped to corresponding project phases, as well as tools, process steps, timetables, measurements, templates, and core team members associated with each project phase. The integrated product development management application 110 breaks down project opportunities business process and project planning processes by phases of project development. In an exemplary embodiment, the phases include concept, plan, develop, qualify, launch, and lifecycle. Each of the project phases is mapped to specified tools (and methodologies), data sources, templates, and core team members via the business rules established by the integrated product development management application 110. Core team members, at each project phase, may select one or more tools, data sources, metrics, timetables, and other criteria as a result of the aforementioned mapping.

At the initial concept phase, one or more core team members access the user interface screen 300 shown in FIG. 3 to identify and explore a project opportunity. A project opportunity may refer to a potential opportunity to generate a new product/service, or improve upon an existing product/service. The business rules applied by the integrated product development management application 110 via user interface screen 300 may be implemented via a value stream map (VSM). The computer screen 300 of FIG. 3 includes options for initiating a project opportunity request. A user at user system 102 enters a name for the project opportunity in field 302 at step 202.

Each core team member may access one of corresponding options 304-314 for analysis and review at step 206. Each of the analyses is implemented by selecting one or more data sources (e.g., 112) and/or tools (e.g., 108) which are mapped to corresponding analysis types at step 204. Results of the analyses performed in step 206 are reviewed by specified core team members at step 208. The results of the analyses are submitted for approval at step 210. Each of the individual analyses will now be described. Each core team member may select one or more options via the user interface screen 300 to initiate an analysis in response to the request for project opportunity. As shown in FIG. 3, the integrated product development management application 110 provides links to data sources and analysis tools via options 304-308. A quality, reliability, availability, and serviceability (QRAS) assessment and a field quality assessment may be initiated by a core team member (e.g., marketing specialist) by selecting option 304 and further selecting an analysis tool for use in performing the QRAS assessment. Once selected, the integrated product development management application 110 redirects the core team member to, e.g., storage device 112 which stores warranty and service records. The warranty and/or service records may be analyzed using the selected analysis tool. The information analyzed may be referred to as voice of the customer (VOC) information. VOC information provides insight as to the quality, reliability, availability, and serviceability of products sold by the enterprise from the viewpoint of its customers. Likewise, a brand specialist and technology specialist may select respective options BRAND ANALYSIS 306 and TECHNOLOGY 308 and corresponding data sources/analytical tools which are mapped to these options are provided to the respective analysts. The technology analysis (e.g., production team core member) may analyze new or improved technologies for a given project opportunity. The results of the QRAS and field analyses may include a top ten list of reliable products. The results of a brand analysis may include a new program opportunity.

In addition, once each of the individual analyses is performed, a collective core project team may analyze/review all of the results of the aforementioned analyses via option 310. The core project team members may determine whether to submit the project opportunity for further review if the results of the analyses are positive (e.g., support the development of a new/improved product). Additional core team members from other departments of the enterprise, e.g., finance specialist, may perform value analysis, such as an economic value added (EVA) analysis by selecting option 312. An EVA analysis results in a financial performance measure of the project opportunity. Again, selecting this option 312 may redirect the finance member to corresponding data/tools that are mapped to this option via the integrated product development management application 110. In addition, there may be several project opportunities that are submitted for review by the finance core team member. If the financial assessment yields positive results, the project opportunity may then be reviewed at the executive level of the enterprise (e.g., an executive-level individual) via option 314. If the project opportunity is not approved at step 212, the results of the analyses performed in steps 202-210 may be stored in a project record in storage device 114 for possible future consideration or review at step 214. For example, results of the QRAS analysis may be stored in QRAS_SCORECARD field 508. Results of the EVA analysis may be stored in EVA field 516.

Otherwise, if the project opportunity is approved at step 212, the executive team member submits the project opportunity by selecting the APPROVE option 316 in FIG. 3 and a project record is created by the integrated product development management application 110 at step 216. As described above, data fields of project record are mapped to corresponding project phases, as well as tools, process steps, timetables, measurements, templates, and core team members associated with each project phase. Each of the project phases is mapped to specified tools (and methodologies), data sources, templates, and core team members via the business rules established by the integrated product development management application 110. Core team members, at each project phase, may select one or more tools, data sources, metrics, timetables, and other criteria as a result of the aforementioned mapping as shown in FIGS. 4 and 5.

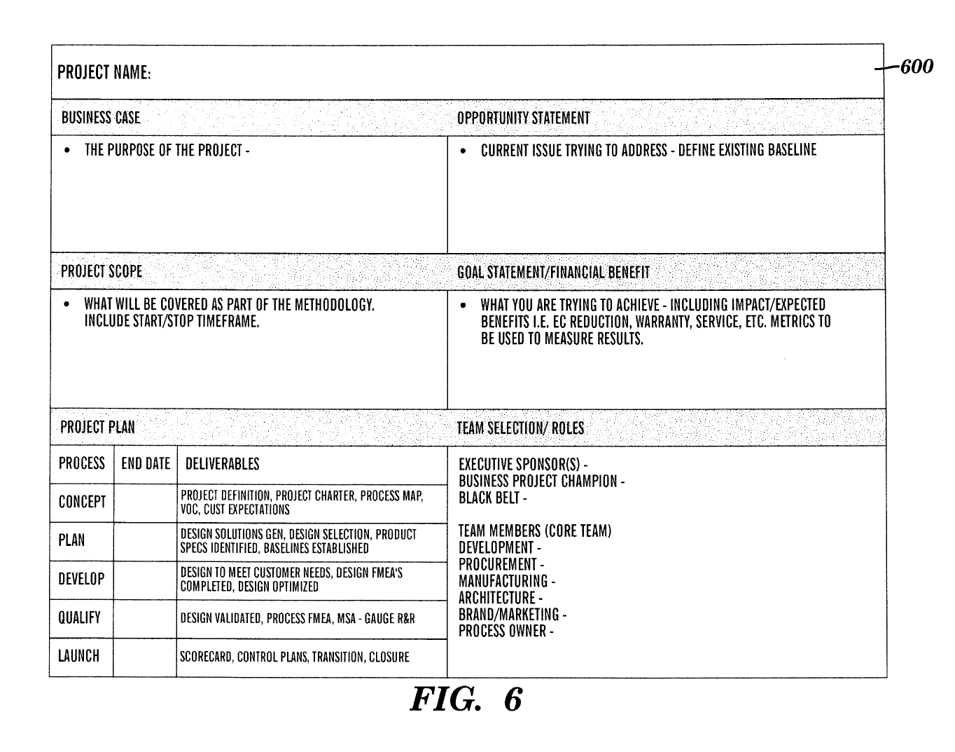

A project plan is created using the project record 500 and user interface screen 400 entries provided by respective core team members at step 218. The approved project opportunity and corresponding project plan may be linked via the project opportunity name/descriptor entered in option 302 and the project option 402, both of which correspond to a PROJECT_ID field 502 and/or PROJECT_DESCRIPTION field 504 in project record 500. For each phase, the integrated product development management application 110 provides a link to project tasks, tools, and data sources via the business rules implemented by the application 110 at step 220. In the initial concept phase, a core team member may select PROJECT CHARTER 404 to enter general data relating to the project definition, stakeholders, etc. A project charter template 600 is shown in FIG. 6. The project charter template 600 identifies project objectives, goals, and metrics to measure progress and may include a desired schedule. A project charter identifier is stored in CHARTER_ID field 506. A core team representing various departments of the enterprise (e.g., executive, finance, marketing, production, etc.) may be selected via option 406 of FIG. 4. A representative core team member may initiate creation of the project plan by selecting the appropriate phase (i.e., concept) via option 408 of FIG. 4. One or more tasks are pre-defined by the business rules of the integrated product development management application 110 and one or more of the pre-defined tasks may be selected via option 410. Based upon the tasks selected, the integrated product development management application 110 may prompt the user to select one or more corresponding tools (e.g., project/analysis tools 108) and/or data sources. For example, in the concept phase, selectable tools may include quality function deployment, Triptych, Kano analysis, etc. for developing a customer definition matrix and requirements. These tools enable the identification of customer requirements that are unique and enable translation of the requirements into engineering specifications by rating strengths of relationships between the customer requirements and the technical requirements provided by the technical specifications.

In addition, the concept phase may include business processes for design innovation. Tools selectable for these processes may include Affinity®, Ishikawa, TRIZ, etc. These tools enable the user to identify desirable factors for a product design and for brainstorming ideas. For each task and/or phase selected, a user may select a timetable for implementing the task via option 414 and a measurement tool via option 416 in window 412.

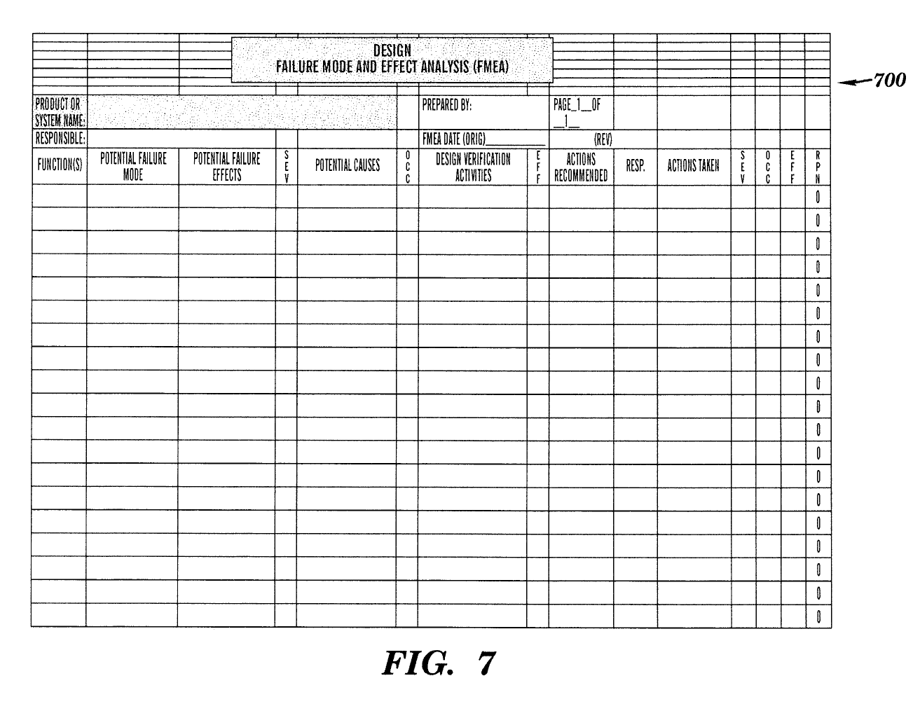

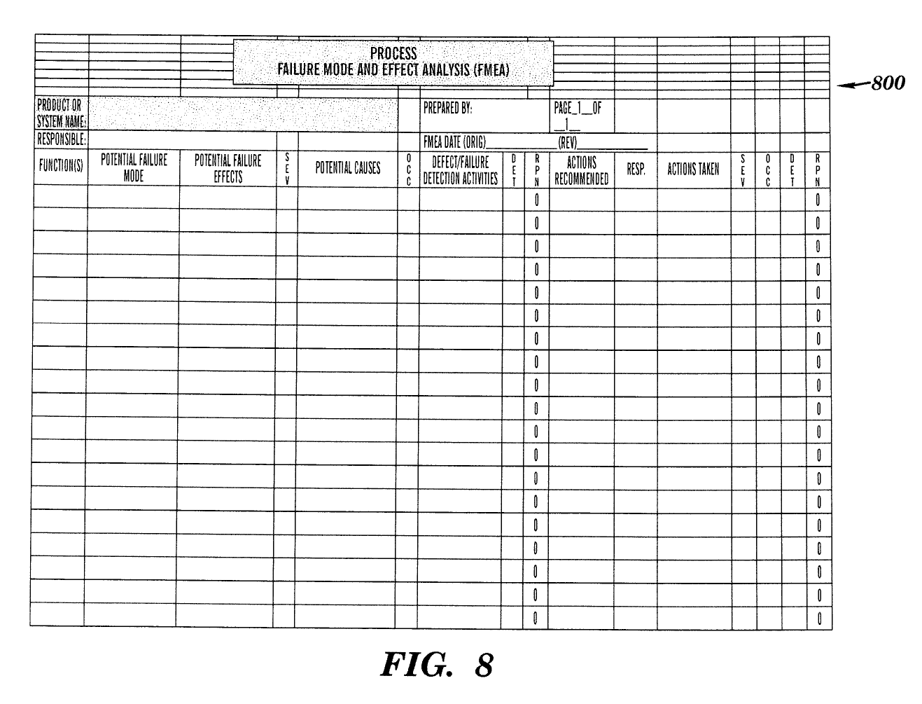

Once completed, the user may go on to select the next phase (e.g., plan) via option 408. Again, various tools, data sources, timetables, measurements, etc., may be selected for a given task. In the plan phase, e.g., a user may select a fault tree analysis (FTA) tool, DOE, Pugh method, Topsis, Supplier selection, measurement analysis (e.g., Gage R&R), as well as templates for providing failure mode effect and analysis data. Exemplary FMEA templates are shown in FIGS. 7 and 8. As with the concept phase, a user may select timetables and measurements for implementing the tasks associated with the plan phase.

By selecting the develop phase via option 408, the user may selects tools, such as FMEA, Minitab® Statistical software, ANOVA, regression analysis, as well as Design tolerance, optimization, Error proofing, capability analysis, reliability analysis, and sensitivity analysis tools and methods. The development phase provides design optimization through statistical data analysis and/or the generation of mathematical models to demonstrate design workability. Timetables and measurement criteria may be selected via window 412 as described above.

By selecting the qualification phase via option 408, the user conducts design validation by selecting one or more of Minitab® statistical software, reliability, sensitivity, an tolerance analysis, error proofing, control plan, and confirmatory testing. The data resulting from this and other phases may be stored in the project record at corresponding data fields for use in researching issues and resolutions from historical project plans. In addition, the data resulting from these phases may be used to identify ongoing issues in the project concept, plan, or development phases that may be adjusted for a current project plan.

By selecting the launch/lifecycle phase via option 408, the user may be prompted to select from one or more Minitab® Statistical Process software, scorecards, control plans, etc. for implementing the project plan and continued monitoring of performance issues relating to the underlying product. This information may be stored in the project record 500 for future research relating to similar projects and/or improvements at step 222.

The data entered for each of the aforementioned phases may be stored in corresponding data fields 510-514 and 518-536 as shown in project record 500 of FIG. 5.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for implementing an end-to-end integrated product development management system, comprising:
providing a user system with a link to a data source and an analysis tool via a user interface in response to a project opportunity selection for a proposed product;
receiving results of an analysis performed by the user system in response to implementing the analysis tool;
creating a project record for the project opportunity selection in response to determining an approval of the project opportunity selection; and
creating a project plan by mapping data fields in the project record to corresponding data entries relating to a project phase, project task, project task tool, project task timetable, project task measurement, data source, and project team selected by the user system via the user interface.

2. The method of claim 1, wherein project phases include:
concept;
plan;
develop;
qualify;
launch; and
lifecycle.

3. The method of claim 2, further comprising:
mapping project tasks, project task tools, and data sources to each of the project phases; and
providing a link to selected one or more of the project task tools and data sources in response to selection of a corresponding project phase in the project plan.

4. The method of claim 2, further comprising:
providing a project charter template upon selection of the concept phase;
receiving projection definition data including objectives, goals, and metrics, via inputs to the project charter template; and
storing the project definition data in the project record.

5. The method of claim 2, wherein the concept phase tools include a customer definition matrix that enables identification of customer requirements and translation of the customer requirements into engineering specifications.

6. The method of claim 2, wherein the concept phase includes business processes for design innovation and tools selectable for identifying desirable factors for a product design.

7. The method of claim 2, wherein the plan phase includes tools for implementing at least one of a fault tree analysis and measurement analysis, and templates for providing failure mode effect and analysis data.

8. The method of claim 2, wherein the develop phase includes tools for providing failure mode effect and analysis, statistical analysis, regression analysis, design tolerance, optimization, error proofing, capability analysis, reliability analysis, and sensitivity analysis.

9. The method of claim 2, wherein the qualification phase includes design validation tools including statistical software, reliability, sensitivity, and tolerance analysis, error proofing, control plans, and confirmatory testing; wherein results of implementing the design validation tools are used to identify ongoing issues in the concept phase, plan phase, or development phase to be adjusted for a current project plan.

10. The method of claim 2, wherein the launch and lifecycle phases include tools including statistical process software, scorecards, and control plans for implementing the project plan and continued monitoring of performance issues relating to the project plan.

11. A system for implementing an end-to-end integrated product development management system, comprising:
a host system executing an integrated product development management application, the integrated product development management application implementing a method, comprising:
providing a user system with a link to a data source and an analysis tool via a user interface in response to a project opportunity selection for a proposed product;
receiving results of an analysis performed by the user system in response to implementing the analysis tool;
creating a project record for the project opportunity selection in response to determining an approval of the project opportunity selection; and
creating a project plan by mapping data fields in the project record to corresponding data entries relating to a project phase, project task, project task tool, project task timetable, project task measurement, data source, and project team selected by the user system via the user interface.

12. The system of claim 11, wherein project phases include:
concept;
plan;
develop;
qualify;
launch; and
lifecycle.

13. The system of claim 12, wherein the integrated product development management application further implements:
mapping project tasks, project task tools, and data sources to each of the project phases; and
providing a link to selected one or more of the project task tools and data sources in response to selection of a corresponding project phase in the project plan.

14. The system of claim 12, wherein the integrated product development management application further implements:
providing a project charter template upon selection of the concept phase;
receiving projection definition data including objectives, goals, and metrics, via inputs to the project charter template; and
storing the project definition data in the project record.

15. The system of claim 12, wherein the concept phase tools include a customer definition matrix that enables identification of customer requirements and translation of the customer requirements into engineering specifications.

16. The system of claim 12, wherein the concept phase includes business processes for design innovation and tools selectable for identifying desirable factors for a product design.

17. The system of claim 12, wherein the plan phase includes tools for implementing at least one of a fault tree analysis and measurement analysis, and templates for providing failure mode effect and analysis data.

18. The system of claim 12, wherein the develop phase includes tools for providing failure mode effect and analysis, statistical analysis, regression analysis, design tolerance, optimization, error proofing, capability analysis, reliability analysis, and sensitivity analysis.

19. The system of claim 12, wherein the qualification phase includes design validation tools including statistical software, reliability, sensitivity, and tolerance analysis, error proofing, control plans, and confirmatory testing; wherein results of implementing the design validation tools are used to identify ongoing issues in the concept phase, plan phase, or development phase to be adjusted for a current project plan.

20. The system of claim 12, wherein the launch and lifecycle phases include tools including statistical process software, scorecards, and control plans for implementing the project plan and continued monitoring of performance issues relating to the project plan.

21. A computer program product for implementing an end-to-end integrated product development management system, the computer program product including instructions for causing a computer to implement a method, comprising:
providing a user system with a link to a data source and an analysis tool via a user interface in response to a project opportunity selection for a proposed product;
receiving results of an analysis performed by the user system in response to implementing the analysis tool;
creating a project record for the project opportunity selection in response to determining an approval of the project opportunity selection; and
creating a project plan by mapping data fields in the project record to corresponding data entries relating to a project phase, project task, project task tool, project task timetable, project task measurement, data source, and project team selected by the user system via the user interface.

22. The computer program product of claim 21, wherein project phases include:
concept;
plan;
develop;
qualify;
launch; and
lifecycle.

23. The computer program product of claim 22, further comprising instructions for implementing:
mapping project tasks, project task tools, and data sources to each of the project phases; and
providing a link to selected one or more of the project task tools and data sources in response to selection of a corresponding project phase in the project plan.

24. The computer program product of claim 22, further comprising instructions for implementing:
providing a project charter template upon selection of the concept phase;
receiving projection definition data including objectives, goals, and metrics, via inputs to the project charter template; and
storing the project definition data in the project record.

25. The computer program product of claim 22, wherein the concept phase tools include a customer definition matrix that enables identification of customer requirements and translation of the customer requirements into engineering specifications.

26. The computer program product of claim 22, wherein the concept phase includes business processes for design innovation and tools selectable for identifying desirable factors for a product design.

27. The computer program product of claim 22, wherein the plan phase includes tools for implementing at least one of a fault tree analysis and measurement analysis, and templates for providing failure mode effect and analysis data.

28. The computer program product of claim 22, wherein the develop phase includes tools for providing failure mode effect and analysis, statistical analysis, regression analysis, design tolerance, optimization, error proofing, capability analysis, reliability analysis, and sensitivity analysis.

29. The computer program product of claim 22, wherein the qualification phase includes design validation tools including statistical software, reliability, sensitivity, and tolerance analysis, error proofing, control plans, and confirmatory testing; wherein results of implementing the design validation tools are used to identify ongoing issues in the concept phase, plan phase, or development phase to be adjusted for a current project plan.

30. The computer program product of claim 22, wherein the launch and lifecycle phases include tools including statistical process software, scorecards, and control plans for implementing the project plan and continued monitoring of performance issues relating to the project plan.
